(19) United States
(12) Patent Application Publication
(10) Pub. No.: US 2012/0124028 A1
(43) Pub. Date: May 17, 2012

(54) Unified Application Discovery across Application Stores

(75) Inventors: Steven Charles Tullis, Redmond, WA (US); Steven William Macbeth, Redmond, WA (US); Ram Nick Talwar, Seattle, WA (US); Viswanath Vadlamani, Sammamish, WA (US); Kamran Rajabi Zargahi, Seattle, WA (US)

(73) Assignee: Microsoft Corporation, Redmond, WA (US)

(21) Appl. No.: 12/944,899

(22) Filed: Nov. 12, 2010

(51) Int. Cl. G06F 17/30

(52) U.S. Cl. 707/711; 707/E17.116

(57) ABSTRACT

Techniques for discovery of applications across a plurality of application stores are described herein. The discovery may be in response to a query and intent process, which may be initiated by a search query. The search query may reveal user intent to discover an application by operation of a search engine. The user intent may be matched with indexed application content. The application content may be obtained by operation of a discovery and indexing process. A crawler may discover and crawl a plurality of application stores. Additionally or alternatively, a feed store may receive direct feeds of application information and links to download locations from a plurality of application stores. Both the discovered data and direct feeds may be sent to an indexer, to create and maintain an index. Search results pages may be returned to provide users with information, links to developer websites and links to download pages from a plurality of application stores.

### BACKGROUND

Increasingly, users install a wide range of applications (also commonly referred to as “apps”) on a wide range of hardware platforms. For example, users install applications on cellular telephones—sometimes called “smart phones”—for literally thousands of purposes. Such applications may be downloaded from a “marketplace” or “app store.” Such an “app store” may be configured as a single organization, typically managed by a cellular telephone service provider or device manufacturer. Accordingly, a cellular telephone provider is able to serve applications (both free and paid) to a captive audience of cellular subscribers. Other device types (TVs, etc.) may be similarly managed to receive applications from a single source.

The downloading process typically involves opening the marketplace application and entering a key word to search for a desired application. Alternatively, the user may click on a button representing a category, such as “games” or “featured.” In either case, the user is presented with a listing of applications from which to choose.

This system is problematic for several reasons. In particular, the user is unable to gain access to applications that are not associated with the application store available to the user. Additionally, the number of applications available to the user at the single application store may be too large to process, due to the inclusion of applications of little interest to the user. Accordingly, the user may be overwhelmed by applications that are of little value to the user, and may be unable to access numerous applications that could be of interest or value.

### SUMMARY

Techniques for discovery of applications in a unified manner across a plurality of application stores in response to receipt of a search query and associated user intent are described herein. The techniques describe the discovery and indexing of applications from the plurality of application stores. Additional techniques describe aspects of processing user queries and deriving intent of a user, including application of factors beyond a scope of the search query.

A discovery and indexing process may create and maintain an index using information from a plurality of application stores. An indexer may receive data from a crawler and/or a feed store. The crawler may discover and crawl a plurality of application stores and send discovered data to the indexer. The feed store may receive direct feeds of application information, links to download locations and metadata from a plurality of application stores. In operation, a user provides a query to a search engine. The query and an associated intent may be determined by a query and intent pipeline. The user may be provided with search results including application information, data, metadata and direct links to an application store for download of a desired application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a diagram illustrating an example of a functional architecture and techniques implementing unified application discovery across a plurality of application stores.

FIG. 2 is a diagram showing example detail of an application discovery service.

FIG. 3 is a diagram illustrating aspects of an example of a well-defined protocol that may be used to provide improved search, management, transfer, download and/or operation of applications.

FIGS. 4 through 8 are examples of search results pages, which may be delivered in response to a user's query and intent and which provide application information, links to application information and links to download sites for the application.

FIG. 9 shows a flow diagram illustrating an example process for providing unified application discovery across a plurality of application stores.

FIGS. 10-12 show flow diagrams illustrating example detail of the process of FIG. 9.

FIG. 13 is a flow diagram illustrating an example process for discovery and indexing of information related to applications, which may include general application information, links to developer websites, links to third party websites and links to download pages for the applications.

### DETAILED DESCRIPTION

The disclosure describes techniques for discovery of applications across a plurality of application stores in response to receipt of a search query and/or associated user intent. The techniques describe examples for the discovery and indexing of applications from the plurality of application stores. Additional techniques describe examples of processing user queries and deriving intent of a user.

In one example, an indexer may create and maintain an index using information from a plurality of application stores. The indexer may receive data from a crawler and/or a feed store. The crawler may discover and crawl a plurality of application stores and send discovered data to the indexer. The feed store may receive direct feeds of application information, links to download locations and metadata from a plurality of application stores.

In operation, a user provides a query to a search engine. The query and an associated intent may be determined by a query and intent pipeline. The user may be provided with search results including application data, links to information websites and direct links to an application store for application download.

Accordingly, the disclosure presents examples of unified application discovery across a plurality of application stores. The examples synergistically combine innovative aspects of query and intent recognition and understanding with innovative techniques of discovery and indexing of applications across a plurality of application stores. The examples presented herein free the user of a device from the limitations of a single source of applications. Moreover, the examples provide for superior searching of application stores, and integration of user intent into the query and searching process.

The discussion herein includes several sections. Each section is intended to be non-limiting. More particularly, this entire description is intended to illustrate components which may be utilized in unified application discovery across a plurality of application stores, but not components which are necessarily required. The discussion begins with a section entitled “Example Unified Application Discovery,” which describes an example environment that may implement application discovery that is “unified” across a plurality of application stores. This section depicts and describes application discovery according to a high-level architecture, including discovery and indexing of applications, and searching an index according to a query and a user's intent. Next, a section entitled “Example Search Results Pages” illustrates several examples of search results pages. A further section, entitled “Example Flow Diagrams” illustrates and describes techniques that may be used to determine intent of a user, to search an index for application matches across a plurality of application stores and to serve search results pages, including direct links to applications. Additionally, techniques are described to discover and index applications over a plurality of application stores, and to create and maintain an index using web crawlers and direct feeds. Finally, the discussion ends with a brief conclusion.

This brief introduction, including section titles and corresponding summaries, is provided for the reader's convenience and is not intended to limit the scope of the claims or any section of this disclosure.

### Example Unified Application Discovery

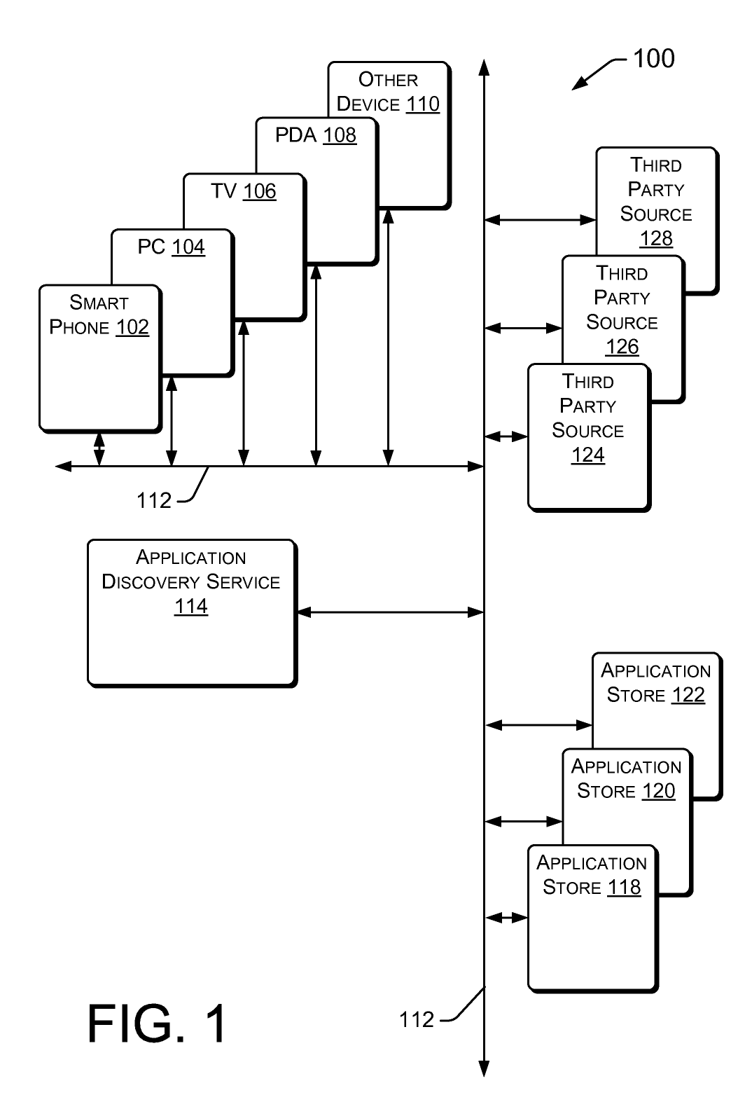

FIG. 1 is a diagram illustrating aspects of an example system 100 configured to implement unified application discovery across a plurality of application stores. Thus, FIG. 1 shows aspects of the discovery and indexing of application information, and query and intent processing to provide appropriate information and links to users. Moreover, the example of FIG. 1 shows techniques and architecture that illustrate more general concepts, and may not show some required and/or necessary elements.

Referring to FIG. 1, the example system 100 is configured to provide or enable application discovery to any application-using device, such as a smart phone 102 (e.g., a cell phone), a PC 104 (e.g., any type of personal computer, such as a laptop, desk top, workstation, etc.), a TV 106, a PDA 108 (e.g., any type of electronic personal digital assistant or information device) or other device 110 having processing ability to execute an application. Examples of other devices 110 may include game consoles, such as X-box 360, and/or many other devices presently in use and/or to be developed. The devices 102-110 may be connected to a network 112, which may include a combination of local area network(s), wide area network(s) and the Internet.

An application discovery service 114 is configured to obtain information about applications using one or more techniques. The information may assist a user to decide if an application (e.g., an application from application stores 118-122) would be appropriately and/or beneficially installed on the user's device, and may assist the user to locate and install the application, if desired. In particular, the application discovery service 114 may discover and index a plurality of applications and associated application information, thereby creating and maintaining an index of application information. Additionally, the application discovery service 114 may provide query and intent processing to evaluate user intent, may search the index using the query and intent, and provide appropriate information and links to users.

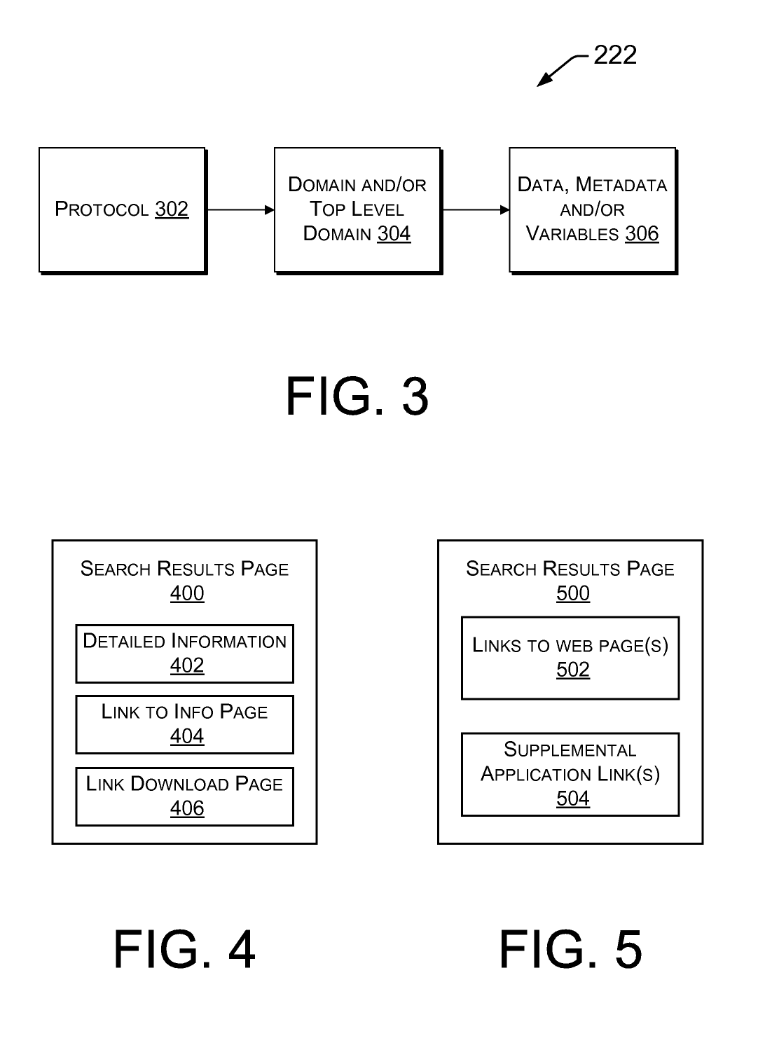

Application stores 118-122 are representative of a potentially large number of application stores present on various networks. Examples of the application stores include Windows® Mobile downloads for Windows® phones, iTunes®, Android® Marketplace and others. Each of the application stores may be configured as a website or other data center to serve one or more applications and related data to users and potential users of applications serviced by that application store. One or more of the application stores 118-122 may be associated with large numbers of applications designed and intended for many purposes and for use with a device of a particular type (e.g., cell phones using a particular operating system). Alternatively, one or more of the application stores 118-122 may be associated with applications and data associated with more than one device, device type, operating system and/or operating system type. As a still further alternative, one or more of the application stores 118-122 may represent a small portion of a larger website, such as a corporate website (e.g., a hotel chain having a small number of downloadable applications to assist customers to obtain hotel reservations). In operation, the application stores 118-122 may be crawled by, and/or provide a data feed to, the application discovery service 114. Accordingly, information from within the application stores 118-122 may be recognized and transferred to the application discovery service 114. To facilitate a unified approach across different device platforms and application stores, a standardized application protocol may be employed, as discussed further with reference to FIG. 3.

Third party sources 124-128 represent sources of information about particular applications. Examples of such third party sources include blogs, wilds, aggregators and crowd-sourced meta-stores. The third party sources may provide information, links to information, and links to application stores and download pages in such stores. For example, a well-respected review site (e.g., a website associated with a magazine) may provide information associated with applications. Such a website may be more trusted by users and potential users than the website maintained by the developer, who may be less well known and/or more commercially involved with promotion of an application. In operation, the third party sources 124-128 may be crawled by, and/or provide a data feed to, the application discovery service 114. Accordingly, information from within the third party sources 124-128 may be recognized and transferred to the application discovery service 114.

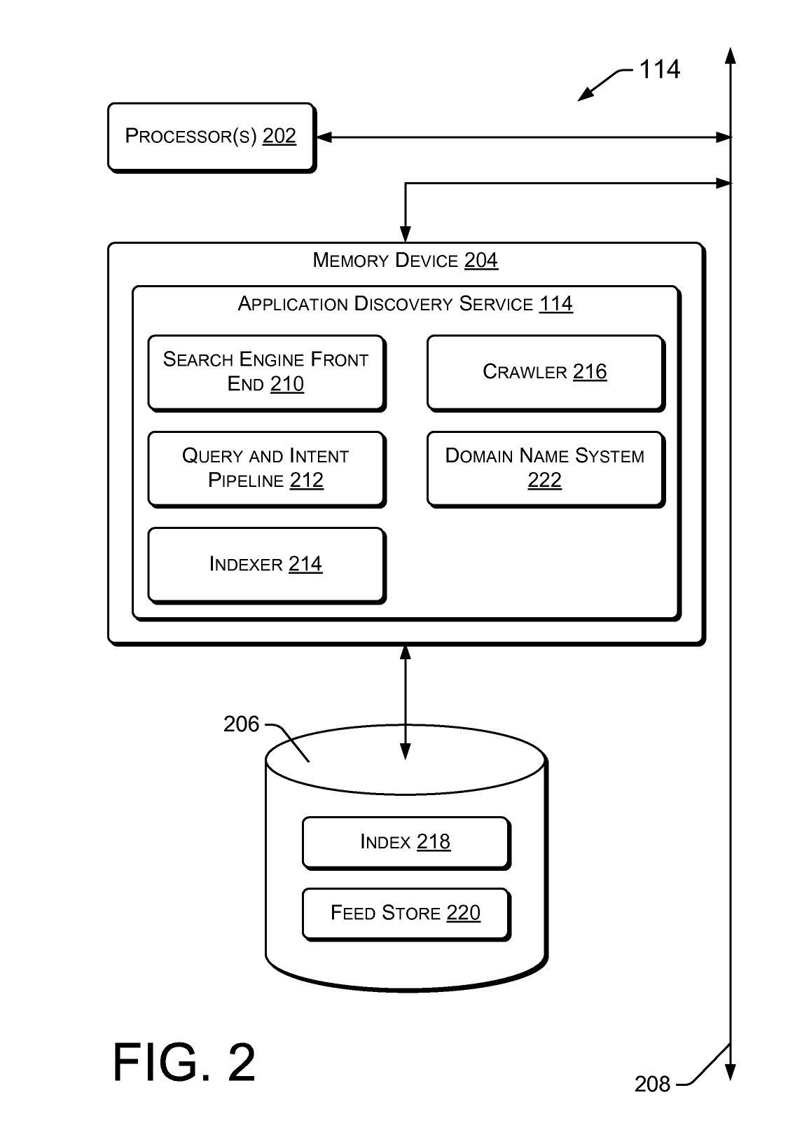

FIG. 2 is a block diagram showing an example of detail of the application discovery service 114 that provides application discovery across a plurality of application stores. The application discovery service 114 may be configured as a server or system of servers, or other computing environment indicated by particular requirements. In this example, processor(s) 202 is in communication with a random access memory device 204 and a persistent memory device 206 over a network 208. The memory devices 204, 206 are exemplary only, may be configured using any appropriate technology, and may be combined or fragmented, as desired. The processor(s) 202 may include a micro processor, a memory management unit, I/O (input/output) devices and/or other information processing devices associated with a server(s), server farm, mainframe or other computing device. The memory device 204 can be a random access device (RAM) or other device and/or technology, as indicated by the needs of a particular application. The memory device 204 may include an operating system and one or more programs (not shown), which may support operation of unified application discovery across a plurality of application stores. The memory device 206 may be a disk, disk array or other device or compound system using any desired technology for random or sequential data access.

The application discovery service 114 may include a search engine front end 210, a query and intent pipeline 212, an indexer 214 and a crawler 216. An index 218 and a feed store 220 may be part of the application discovery service 114 or remotely located on an available memory device (e.g., disk or disk array 206). In one example, the search engine front end 210, the query and intent pipeline 212, the indexer 214 and the crawler 216 and/or other functional blocks are configured as software programs. Such programs can include computer-readable and/or processor-readable statements defined on computer-readable and/or processor-readable media, which when executed by the processor 202, result in execution of one or more methods, such as methods of unified application discovery across a plurality of application stores.

A search engine (e.g., the combined search engine front end 210, query and intent pipeline 212, indexer 214, crawler 216) is able to communicate with the devices 102-110 (seen in FIG. 1) over a network, such as the Internet. In particular, the search engine front end 210 is able to receive queries from the devices 102-110. The queries may be generated by the devices 102-110 in response to user interaction with the device. Alternatively or additionally, the queries may be generated by applications operating on one of the devices 102-110 with little or no user interaction. For example, an application running on a device 102-110 may execute a query periodically to see if an updated version of that application is available, or to generate periodic unsolicited reports (e.g., weather updates) to the user.

The search engine front end 210 is also configured to return search results pages to a user. The search results pages may be presented in a format that is consistent with the display characteristics and abilities of the device 102-110, on which the search results page is displayed. Thus, the search engine front end 210 may be configured to return search results in a format that is optimized for display on the device from which the search query originated.

A query and intent pipeline 212 is in communication with the search engine front end 210 and an index 218. The query and intent pipeline 212 intuits intent of a user who issues a query to the search engine front end 210. The intent may be derived from analysis of parameters associated with the query, from information associated with the device used to make the query, and/or from information known about the user making the query. For example, the query and intent pipeline may derive intent of a user by examination of a user's history of Internet searches, the user's history of Internet sites visited, the cookies or other software objects and/or programs installed on the user's device, and/or the user's history of application downloads and/or other factors based on a particular situation.

An index 218 may contain information about, and/or links to, a plurality of applications. For example, the index 218 may include information that a user would evaluate before installing one of the plurality of applications on a device. Additionally, the index 218 may include links to a website of a developer and/or promoter of some or all of the plurality of applications. Following the link may provide the user with additional information about the application and related information about the developer and related applications. The index may also include links to an installation page within an application store (e.g., installation pages within application stores 118-122). By following such a link, the user is able to directly download and install the application on a device 102-110 associated with the user.

An indexer 214 may ingest data and utilize the data to create and/or maintain the index 218. In particular, the indexer 214 may obtain information from a crawler 216 and/or a feed store 220. Once obtained, the information may be processed and included in the index 218.

The crawler 216 is particularly configured to search and crawl a plurality of application stores 118-122. Examples of application stores that may be included within the plurality include the Window® Mobile application store, the “Google Apps Marketplace” or the “iTunes® Official Store.” Additional examples of application stores may include developer websites which promote and distribute relatively limited numbers of applications. And further, corporate websites (e.g., a hotel chain) may include a small number of downloadable applications on a website to provide customers with a convenient way by which to communicate with the corporation (e.g., to obtain hotel reservations). Such application stores should expose their pages so that they may be crawled by the crawler 216. Accordingly, the crawler 216 may obtain information about applications, links to web pages that include information, and links to web pages which provide for the download of an application.

The feed store 220 may receive an information feed, such as RSS, from one or more application stores. The feed store 220 may retain such information until transmitted to the indexer 214. The information received, stored and transmitted by the feed store 220 may include information about applications from a plurality of application stores 118-122 and third party sources 124-128. Such information may also include links to web pages that include information, and links to web pages which provide for the download of an application. Accordingly, the feed store 220 and the crawler 216 may both obtain similar information about application stores. However, the crawler 216 and the feed store 220 may obtain such information from different application stores.

The domain name system 222 provides an optional element, which may be included within the application discovery service 114. The domain name system 222 implements a well-defined protocol that may be used to allow a search provider (e.g., the search engine front end 210 of FIG. 2) to search, manage, transfer and/or operate an application. In some cases, a call to an application may allow operation of the application without installation on the user's device. Such operation may be useful, for example, to test or evaluate the application. Such a call to the application may be made with contextual information, such as input parameters to the application. A more robust implementation of the domain name system 222 includes provisions to manage and/or transfer additional information. For example, the protocol may pass data or metadata for use by a receiving application. In one such example, the data may be used to set variables or other programming constructs within the application.

Referring to FIG. 3, the domain name system 222 may define a protocol. As such, the domain name system 222 may be analogous to the domain name server (DNS) technology employed to direct browser requests for uniform resource locators (URL) on the Internet. Accordingly, the domain name system 222 supplements and/or replaces DNS technology. In particular, the protocol defined by the domain name system 222 provides enhanced methods of locating, operating, managing, downloading and installing of applications on devices. In one example, the domain name system 222 may be used in conjunction with the crawler 216 and/or feed store 220 of FIG. 1. In conjunction with the crawler 216 or feed store 220, the domain name system 222 may provide better search, management, transfer, etc., of applications. Accordingly, the protocol may replace or supplement the familiar http protocol (hypertext transfer protocol) used to transfer and format text and images. The “app://” protocol could be standardized across all applications (e.g., the “apps” used by smart phones, TVs and other devices) and could encourage wide adoption by developers. The protocol may be managed in part by the domain name system 222, and may be invoked by identifying or indicating the following aspects: the protocol 302, a domain and top level domain 304 and indicated data, metadata and/or variable information 306.

In one example, the protocol 302 may be identified by a name; for example, “app://”. Accordingly, a name such as “app://” may identify a protocol to replace the familiar http:// protocol. The domain and/or top level domain 304 may be identified (strictly for purposes of example only, and not as a required feature) as “microsoft.bing,” optionally with a top level domain such as “.com” or “.org.” This is by way of example only, and the example would allow a user to access and/or manage an application associated with the Bing® service provided by Microsoft®. In a further example, the domain level 304 could be indicated by “corporation.department” or similar, as required to indicate a particular application or resource. The data, metadata or variables 306 may include, by way of example and not limitation, one or more search term(s) used to find an application, input variable values for use by a specifically identified application or a command to an application and/or to an application store, server or host of the application.

### Example Search Results Pages

FIGS. 4-8 are diagrams showing examples of search results pages. The search results pages may be provided by the search engine front end 210 to a user of a device, such as devices 102-110 (e.g., FIG. 1). Different formats may be used to configure the search results page, and FIGS. 4-8 are representative examples of some of those formats. FIG. 4 shows a search results page 400 having information organized as an algorithmic caption. The search results page 400 provides detailed information 402 about the application. Additionally, one or more of link(s) 404 to an information page and link(s) 406 to a download page may be provided. In particular, link(s) 404 to an information web page may be directed to a web page provided by the developer, which may explain and promote the application. Alternatively, link(s) 404 to an information web page may be directed to a web page provided by an application reviewer or critic. Additionally, link(s) 406 to a download page may be directed to a specific page within an application store (e.g., application store 118 of FIG. 1), at which location the user may download the application.

FIG. 5 shows a search results page 500 having information organized as part of an algorithmic caption together with links to supplemental or “helper” applications. In particular, links 502 to web pages are provided as part of the algorithmic caption, together with supplemental application links 504. In this example, the supplemental application links 504 may be “helper” applications or information that is related to the links 502, which may constitute information of the caption. For example, if the user submits a query to a search engine for “banking,” an algorithm result 502 may include a link to a particular bank. In addition to this caption, which contains information about the particular bank, there is an additional link(s) 504 that takes the user to an application store to download an application related to the particular (or another) bank.

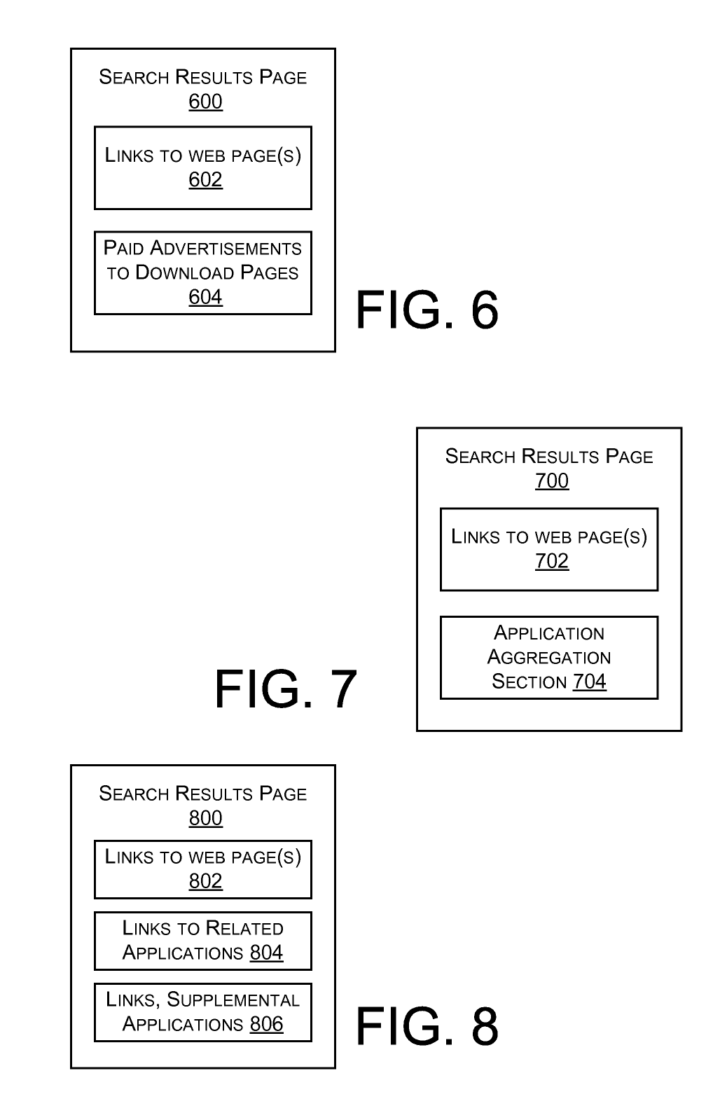

FIG. 6 shows a search page 600 having one or more links 602 to web pages. These links 602 may result as part of an algorithmic caption, similar to the links 502 in FIG. 4. Additionally, the search page 600 may provide links 604 which are paid advertisements that link to download pages of applications. In particular, the links 604 may be associated with applications that are related to the links 602, which resulted from a query entered by a user.

FIG. 7 shows a search return page 700 having links to web pages and links to applications. In the example, a section 702 of links to web pages(s) may be returned as part of the algorithmic caption. Additionally, an application aggregation section 704 may be provided, within which a plurality of links to applications are aggregated. As applications become more prevalent, it is likely that multiple applications will be returned in response to a query. In this case, a special section of the search return page 700 may be dedicated to showing an aggregated view of all applications returned. In operation, a user might click on links to applications in the application aggregation section 704 to go to either an application information page or to an application download page within an application store.

FIG. 8 shows a search return page 800 having links 802 to web pages that result from a user query and that form the algorithmic caption. Additionally, the search return page 800 provides links 804 to applications that are related to subject matter of the links 802. Such applications, upon installation and operation, may provide the user with much the same information as the web pages at links 802. Further, the search return page 800 may provide links 804 to applications that were not specifically indicated by a user's query. However, such applications may be supplemental and/or useable in conjunction with applications associated with links 804. Thus, a user's query may result in a search results page 800 having appropriate links 802 to web pages, links 804 to applications to the subject matter of the web pages, and links 806 to applications that may be supplemental or used in conjunction with the applications associated with links 804.

### Example Flow Diagrams

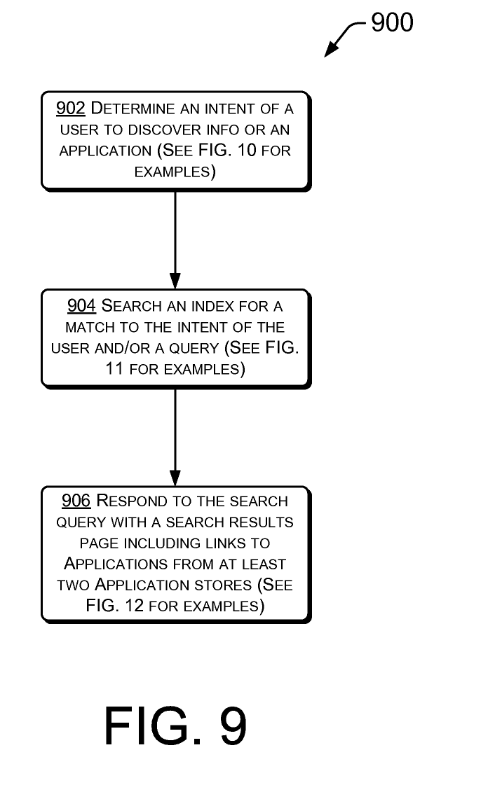

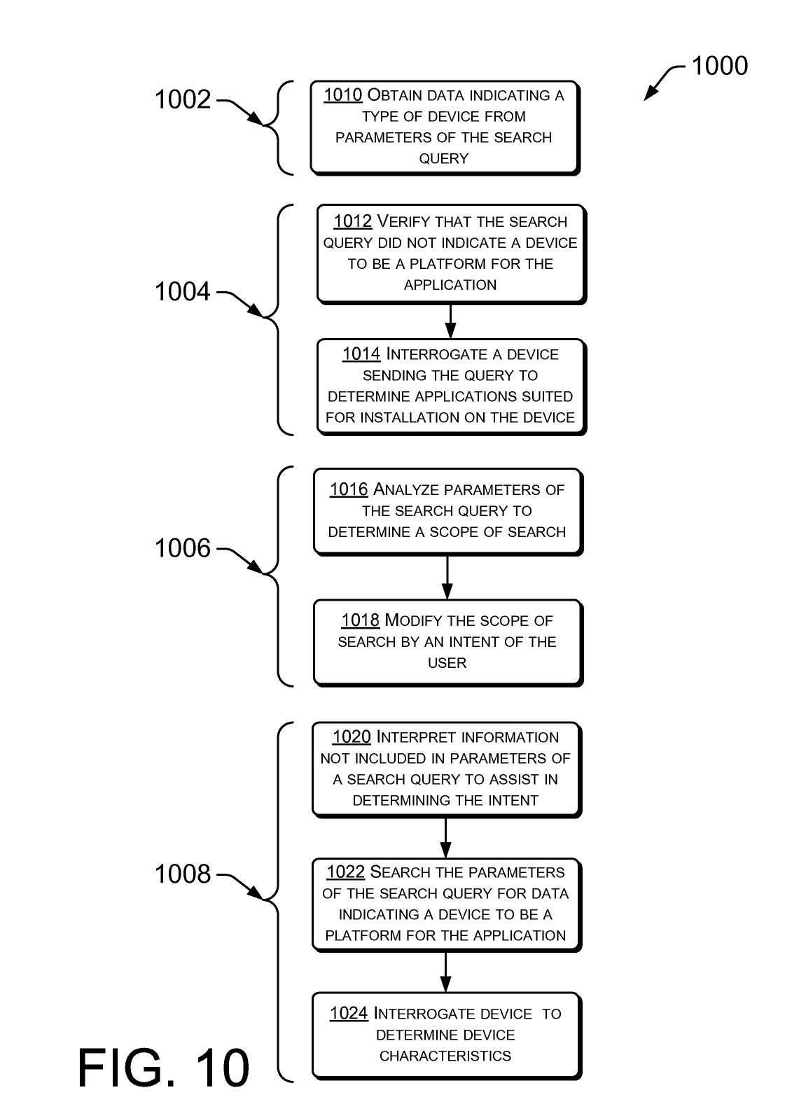

The flow diagram of FIG. 9 constitutes an example process 900 for providing unified application discovery across multiple application stores. The flow diagrams of FIGS. 10-12 constitute examples and optional implementations for several of the operations of the process 900. The example process 900 can be understood in part by reference the configuration of FIGS. 1-8. However, example process 900 contains general applicability, and is not limited by other drawing figures and/or prior discussion.

Each process described herein is illustrated as a collection of blocks in a logical flow graph, which represent a sequence of operations that can be implemented in hardware, software, or a combination thereof In the context of software, the blocks may represent computer-executable instructions stored on one or more computer-readable storage media that, when executed by one or more processors, perform techniques such as unified application discovery across multiple application stores. The order in which the operations are described is not intended to be construed as a limitation, and any number of the described blocks can be combined in any order and/or in parallel to implement the process. The above discussion may apply to other processes described herein.

At operation 902, intent of a user to discover information or an application is determined. In one example, the query and intent pipeline 212 of FIG. 2 may be used to determine the intent. The query and intent pipeline may communicate with the search engine front end 210 (see FIG. 2) to derive intent from search parameters and information not included within the parameters, such as device type, network factors, geographic location, demographics, etc. Determining user intent may be a useful step in the discovery of an application through operation of a search engine. In particular, user intent may be matched with indexed application content during the searching process.

At operation 904, an index may be searched for a match to the intent of the user and/or a query provided by the user. Determining intent may be a useful step in the discovery of an application through operation of a search engine. For example, user intent may be matched with indexed application content during the searching process.

At operation 906, the search query is responded to with a search results page, which may include links to applications within at least two application stores. By providing links to applications that are within at least two application stores, operation 906 provides greater utility than is provided by traditional application stores, which are configured and able to search for applications only within a single store.

FIG. 10 provides four example scenarios 1002-1008, each showing optional aspects of the operation of block 902 of FIG. 9. In particular, examples 1002-1008 show aspects of intent of a user to discover information or an application. At example 1002, aspects of intent are discussed, and particularly how intent may be determined. In particular, at operation 1010 data is obtained indicating a type of device from parameters of the query sent by the user to a search engine. For example, a query sent by the user may provide all relevant information concerning the user's device that is needed to derive the user's intent. The user's intent may clarify any questions regarding applications and/or application information desired by the user.

At example 1004, aspects and techniques of determining intent are discussed, and particularly how intent relates to a type of device operated by the user. At operation 1012, the search query is examined to determine whether the query contains an indication of a device to be used as a platform for an application. Optionally, it may be determined if the query contains all needed information regarding the device in question. In particular, the search parameters may be examined for an obvious sign, such as the name of a device as one of the search parameters. In the absence of such information in the query, it may be verified that the search query does not indicate a device to be used as a platform for the application, or did not indicate some or all relevant aspects of a device. At operation 1014, the device used to send the query may be interrogated to determine the type of the device and to determine what type of application(s) is suited for installation on the device. The type of the device can be based on a number of factors, such as hardware make, model and revision, software version, firmware version, network type and speed, etc. Thus, if the query did not specify the device type or other needed information, then the interrogation may be used to determine the device type or other needed information. Moreover, if aspects of the device were disclosed in the query (e.g., the make/manufacturer of a smart phone) but other aspects were not disclosed (e.g., the model of the smart phone) then the interrogation may reveal the non-disclosed aspects.

At example 1006, aspects and techniques of determining intent are discussed, and particularly how intent may be used to modify a scope of a search. In one example, the scope of search may be modified by intent of the user. The intent of the user may be determined by subjective interpretation of information other than parameters of the search query. At operation 1016, parameters of a search query are analyzed to determine a scope of the search. At operation 1018, the scope of the search is modified by intent of the user. For example, if the search explicitly indicates certain aspects, those aspects may be modified and/or supplemented by the intent of the user. Modifications may alter the scope of the search by providing a better indication of the make, model, and revision level, etc., of the device on which the application is to be operated. Knowledge of the user's intent may alter the scope of the search by providing additional information in the query, such as by tying the search to a geographic region of the user or to network limitations experienced by the user. Such user intent may modify both the query and associated search results page.

At example 1008, aspects and techniques of determining intent are discussed, and particularly how a search may be refined by aspects not included in parameters of the search, and how a device used to formulate the search can be interrogated. At operation 1020, information not included in parameters of a search query is interpreted to assist in determining intent of the user. Such information may be extremely varied, and may include such factors as a location of the user, network capabilities of the user's network, applications already installed on the user's device, usage of the applications installed, previous queries by the user, the user's device and/or the device upon which the query was made and other factors. At operation 1022, the parameters of the search query may be searched for data indicating a device to be used as a platform for an application. The parameters may or may not fully describe the device. At operation 1024, the device sending the search query may be interrogated by the application discovery service 114 to determine characteristic of the device and to resolve any deficiencies in the description of the device.

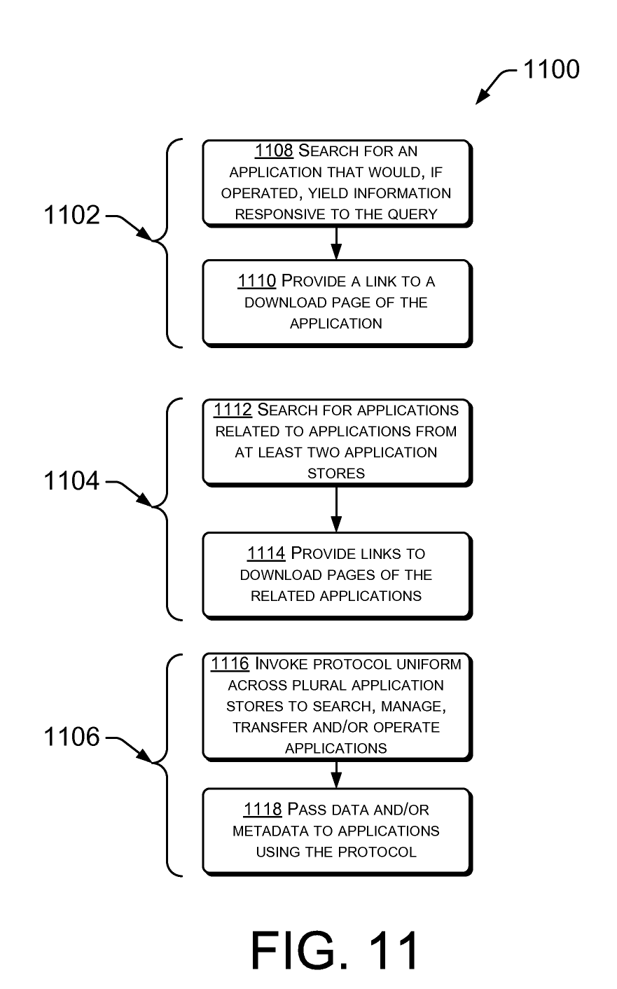

FIG. 11 provides three example scenarios 1102-1106, each showing optional aspects of the operation of block 904 of FIG. 9. In particular, examples 1102-1106 show aspect of how an index may be searched for a match to the intent and/or query of a user.

At example 1102, an index is searched for an application that could provide information that matches the intent of the user. Thus, the user may or may not have been searching for an application. At operation 1108, a search is made for an application that would, if operated yield information that is responsive to the user's query. At operation 1110, a link is provided to a download page of the application.

At example 1104, the search of the index for a match to user intent may be expanded to include applications to the user's intent. Such an expanded search may provide added utility, particular for a user not fully aware of the scope of information and application available. At operation 1112, an index is searched for applications that are related to those that were found in two or more application stores and that match the user's intent. The relationship may be one of a related focus or purpose of the application; alternatively, the relationship may be one of a cooperative functionality, such as a “helper application.” In one example, the index 218 (seen in FIG. 2) is searched for applications that are related to those found based on a match to the user's intent (e.g., the intent found at operation 902 of FIG. 9). At operation 1114, a link(s) are provided to a download page(s) of the related application(s).

At example 1106, the search of the index for a match to user intent can be performed in part by operation of a well-defined protocol. At operation 1116, a protocol is invoked to search, manage, transfer and/or operate applications distributed across plural application stores. In one example, the protocol may be configured as indicated by the domain name system 222 of FIG. 2. At operation 1118, data and/or metadata may be passed to applications using the protocol. Accordingly, an application may be discovered, managed, transferred and/or operated according to the data provided.

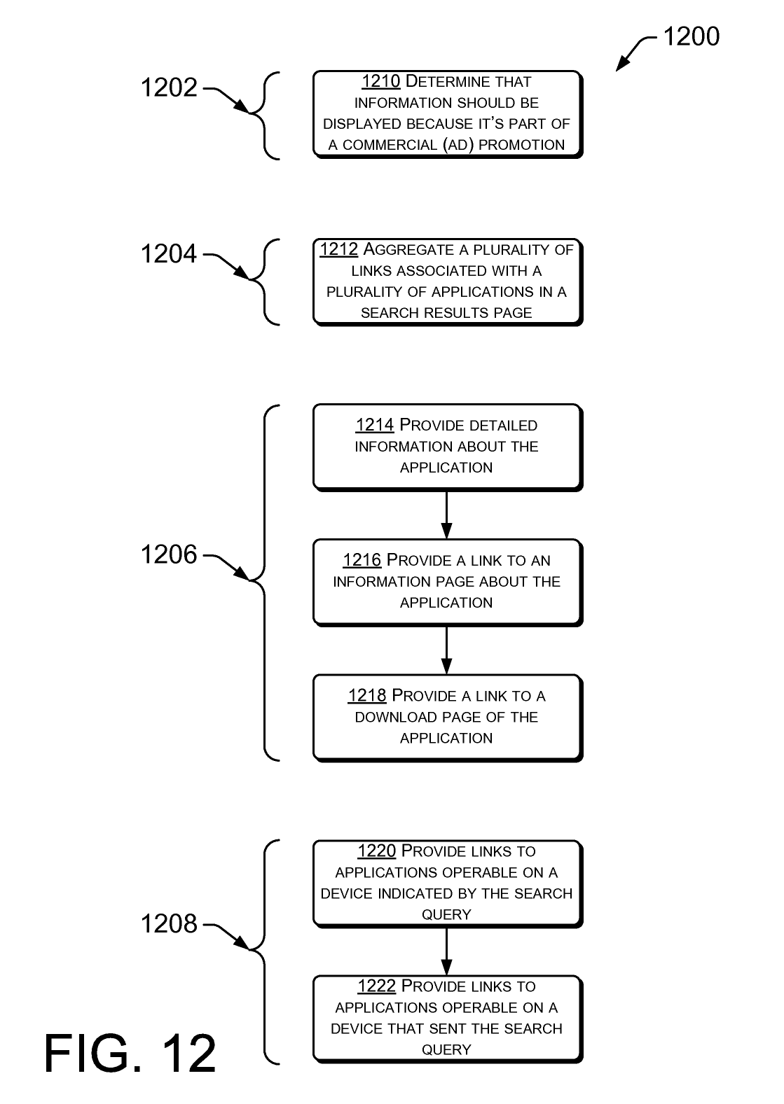

FIG. 12 provides four example scenarios 1202-1208, each showing optional aspects of the operation of block 906 of FIG. 9. In particular, examples 1202-1208 show aspects of how a search results page, including links to applications within at least two application stores, may be provided in response to a search query and/or the intent of a user.

At example 1202, information may be displayed because it is paid advertising. Thus at operation 1210, information is displayed if it is determined that it is part of an advertising promotion. Such advertising information may be related to the objective search parameters of the user's query. Additionally, the advertising information may be related to the user's intent.

At example 1204, links may be aggregated on the search page. This may result in separate sections for links to web pages, links to application information and links to application download pages. At operation 1212, a plurality of links, associated with a plurality of applications, are aggregated in a particular section of a search results page. This aggregation accommodates applications, as they become more prevalent and multiple application links are returned by searches.

At example 1206, the search query page returned by operation 906 of FIG. 9 may include one or more of a number of aspects. At operation 1214, detailed information about the application is provided. This information may include almost any information relevant to the application, such as screen-shots of the application in operation, information about its utility, requirements and/or benefits to the user. At operation 1216, link(s) to an information page (e.g., a web page) about the application are provided. Such information web pages may be published or provided by a wide range of content authors. For example, the developer of an application may publish information pages about their products or offerings. Such information or pages may be informative, but may also be commercially oriented. As a further example, third party critics and reviewers may publish information regarding their experiences and opinions regarding applications. Links to such pages may provide less biased information and/or a different perspective on the application. At operation 1218, link(s) to a download page(s) of the application are provided. In one example, a download page may be found in one or more application store (e.g., application store 118 of FIG. 1). Additionally or alternatively, the download page may be at the developer's website (i.e., the developer of the application). As a further additional or alternative, the application download page maybe a corporate site (e.g., a hotel sponsoring an application to reserve rooms at that hotel may provide a download page).

At example 1208, further optional aspects of the operation of block 906 in FIG. 9 are provided. For example, the search query page returned by operation 906 may include links to applications configured to operate on an appropriate device. Because different devices require different executable code to result in similar functionality, and because there are so many devices on which applications operate, many or most applications are incompatible with any particular device. Accordingly, the search query page must return links calculated to be appropriate to a particular device. At operation 1220, the search results page provides links to applications operated on a device indicated by the search query. In some instances, the user may explicitly indicate the type of device in the search query. In this instance, links to applications appropriate for the search are returned. At operation 1222, the search results page provides links to applications that are operable on a device that sent the search query. Information about the device, and therefore what applications would be compatible, may be available in part due to interrogation of the device.

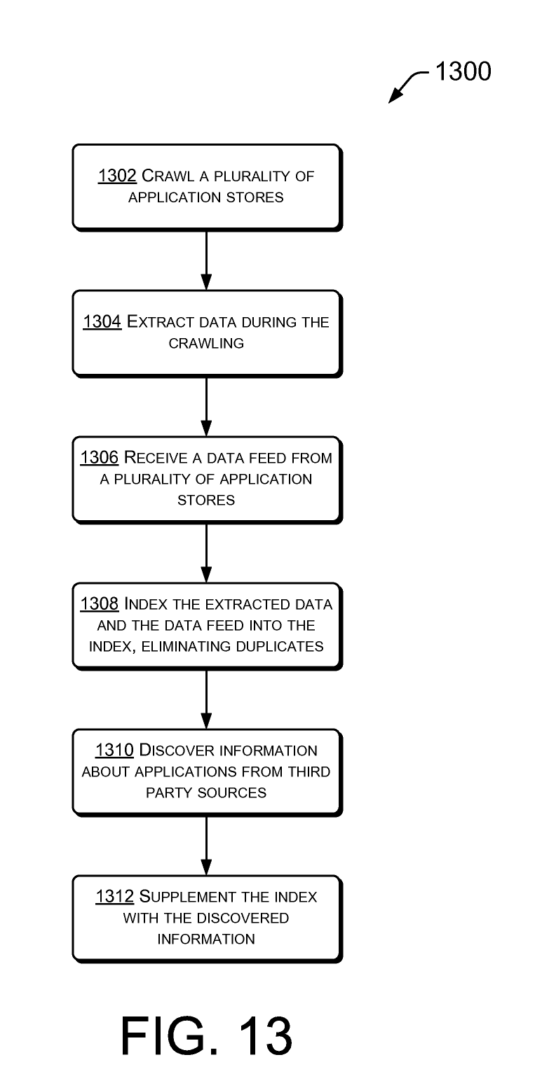

FIG. 13 is a flow diagram illustrating example processes 1300 for discovery and indexing of information related to applications. The information may include general application information, such as an intended device platform, what the application does and its benefits of operation, etc. The information may also include links to developer websites, i.e., the creators of the applications. Such websites may include more technical information that is known by other sources, but may also include biased or commercial content. The information may also include links to third party websites, such as reviewers and critics of the application(s) and links to download pages for the applications.

At operation 1302, a plurality of application stores are crawled. The crawling process may be performed by a crawler, such as crawler 216 seen in FIG. 1. A plurality of application stores, such as application stores 118-122 seen in FIG. 1, may be accessible to the crawler 216. Such application stores may be accessible over the Internet or other network. In particular, the crawler may be able to crawl a plurality of application stores that have exposed their information to allow access by a crawler. Such exposure may be provided by application stores to provide greater publicity and to attract potential users.

Optionally, the protocol defined and enabled by the domain name system 222 of FIG. 2 may be used to crawl application stores. The crawling may be performed by invoking the protocol—which may be uniform across a plurality of application stores—to search, manage and transfer applications. The plurality of application stores could then be crawled using the protocol defined and enabled by the domain name system 222 of FIG. 2. Data obtained by the crawling could be used to configure the index.

At operation 1304, data is extracted during the crawling. As a result of the crawling, data is obtained from a plurality of application stores. Moreover, the data are more complete than the data within any single application store. Accordingly, users having access to this data are better able to analyze, select and download appropriate applications.

At operation 1306, a data feed is received from one or more application stores. Such a data feed may be transmitted according to any technology desired, such as RSS or others. A data feed may be a more convenient and effective method of data transfer than having a crawler explore an application store.

At operation 1308, the data extracted from the crawling and the data feed(s) are indexed into an index. In the example of FIG. 2, the crawler 216 and feed store 220 both provide data and information to the indexer 214, which creates and maintains an index 218. In one implementation, the indexer removes duplicates, which may result from overlapping crawling and data feeds.

At operation 1310, information about applications from third party sources may be discovered, such as by crawling or by data feed. Such third party sources may include sources other than application stores and users. Specifically, such sources may include developer websites, corporations offering downloadable applications assisting customers to make purchases, application reviewers, critics, news reports and all other information about applications.

At operation 1312, the index is supplemented by any/all additional available information, such as that obtained from operation 1310. In the implementation of FIG. 2, the indexer 214 provides the information to the index 218.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable media storing computer-executable instructions that, when executed, cause one or more processors to perform acts comprising:
receiving a search query;
determining an intent of a user to discover an application in response to receipt of the search query;
searching an index, the index including information about applications associated with a plurality of application stores, for a match to the intent of the user; and
responding to the search query with a search results page having links to at least one application from each of two application stores.

2. One or more computer-readable media as recited in claim 1, wherein determining the intent comprises:
verifying that the search query did not indicate a device to be a platform for the application; and
interrogating a device sending the search query to determine a type of application suited for installation on the device.

3. One or more computer-readable media as recited in claim 1, additionally comprising:
invoking a protocol that is uniform across a plurality of application stores to search, manage and transfer applications;
crawling a plurality of application stores using the protocol; and
using data obtained by the crawling to configure the index.

4. One or more computer-readable media as recited in claim 1, wherein searching the index comprises:
searching for applications that are related to an application from among the at least one application from each of two application stores; and
providing links to download pages of the related applications.

5. One or more computer-readable media as recited in claim 1, wherein searching the index comprises:
searching for an application that would, if operated, yield information responsive to the query; and
providing a link to a download page of the application.

6. One or more computer-readable media as recited in claim 1, wherein responding to the search query comprises:
determining that information about an application should be displayed as part of the search results page because the information is not inconsistent with the search query and because the information is indicated as an advertisement.

7. One or more computer-readable media as recited in claim 1, wherein responding to the search query comprises:
aggregating a plurality of links associated with a plurality of applications, including the at least one application from each of two application stores, within the search results page, wherein the plurality of links comprise links to an information page associated with each of the plurality of applications and links to an installation page for each of the plurality of applications.

8. One or more computer-readable media as recited in claim 1, wherein responding to the search query comprises:
providing detailed information about an application;
providing a link to an information page, the information page including information about the application; and
providing a link to a download page of the application.

9. One or more computer-readable media as recited in claim 1, additionally comprising:
receiving a feed from an application store, wherein the feed comprises application information; and
indexing the feed into the index.

10. One or more computer-readable media as recited in claim 1, additionally comprising:
crawling a plurality of application stores;
extracting data during the crawling;
receiving a data feed from a plurality of application stores;
indexing the extracted data and the data feed into the index; and
removing duplicates between the extracted data and the data feed.

11. One or more computer-readable media as recited in claim 1, additionally comprising:
discovering information about applications from third party sources, comprising blogs, wikis, aggregators and crowd-sourced meta-stores; and
supplementing the index with the discovered information.

12. One or more computer-readable media storing computer-executable instructions that, when executed, cause one or more processors to perform acts comprising:
crawling a plurality of application stores;
extracting data during the crawling; and
indexing the extracted data into an index.

13. One or more computer-readable media as recited in claim 12, additionally comprising:
receiving a data feed from a plurality of application stores; and
indexing the data feed into the index.

14. One or more computer-readable media as recited in claim 12, additionally comprising:
receiving a search query;
determining, at least in part from the search query, an intent to discover an application;
searching the index for information about applications associated with the plurality of application stores and for a match to the intent; and
responding to the search query with a search results page having links to an application from each of at least two application stores.

15. One or more computer-readable media as recited in claim 14, wherein determining the intent comprises:
analyzing parameters of the search query to determine a scope of search; and
modifying the scope of search by an intent of the user, wherein the intent of the user is determined by subjective interpretation of information other than the parameters of the search query.

16. One or more computer-readable media as recited in claim 14, wherein the responding comprises:
providing links to applications operable on a device indicated by a parameter of the search query; and
providing links to applications operable on a device that sent the search query.

17. A method for unified application discovery across multiple application stores, comprising:
under control of one or more processors configured with executable instructions:
crawling a plurality of application stores;
extracting data during the crawling;
receiving a data feed from a plurality of application stores;
indexing the extracted data and the data feed into an index;
receiving a search query;
determining an intent, based in part on the search query, to discover an application;
searching the index, in response to the search query, for information about applications associated with the plurality of application stores and for a match to the intent; and
responding to the search query with a search results page having links to an application from each of at least two app stores.

18. The method of claim 17, wherein determining the intent comprises:
interpreting information not included in parameters of a search query to assist in determining the intent;
searching the parameters of the search query for data indicating a device to be a platform for the application; and
interrogating a device that is sending the search query to determine a type of the device and a type of applications suited for installation on the type of the device.

19. The method of claim 17, wherein responding to the search query comprises:
providing detailed information about the at least two applications;
providing a link to an information page for each of the applications from each of at least two app stores, the information pages including information about the at least two applications; and
providing a link to a download page of each of the at least two applications.

20. The method of claim 17, wherein responding to the search query comprises:
providing links to applications operable on a device indicated by the parameters of the search query; and
providing links to applications operable on a type of the device indicated by the interrogating of the device.
